(19) United States
(12) Patent Application Publication
(10) Pub. No.: US 2013/0170925 A1
(43) Pub. Date: Jul. 4, 2013

(54) Book Binding Adhesive Application Controller

(71) Applicant: Donnie Donselman, Danville, KY (US)

(72) Inventor: Donnie Donselman, Danville, KY (US)

(21) Appl. No.: 13/727,716

(22) Filed: Dec. 27, 2012

Related U.S. Application Data
(60) Provisional application No. 61/580,910, filed on Dec. 28, 2011.

(51) Int. Cl. B42C 9/00; B42C 99/00

(52) U.S. Cl. CPC B42C 9/0006; B42C 99/00
USPC 412/11; 412/37; 412/13

(57) ABSTRACT

A device for controlling the application of glue on the spine of a book. The device consists of a computerized controller that tracks the precise location of the book in the binding system, and a servo motor that controls a doctor blade, the servo motor is connected to the controller and is instructed when to open or close the doctor blade at the precise time to precisely place the glue on the book spine. The doctor blade can also be adjusted to control the thickness of the glue on the book spine.

### CROSS REFERENCE TO RELATED APPLICATIONS

This application is a continuation of U.S. application 61/580,910, filed on Dec. 28, 2011, and incorporated herein by reference.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates to a device for controlling the application of glue to the binding of a book or magazine during the book binding process. More specifically the device relates to a computer controlled servo-motor and cam that can precisely adjust the distance from a doctor blade to the glue wheel to precisely control the thickness, and the application, of the glue applied during the book binding process.

2. Description of the Related Art

The process of book binding is well know and the subject of numerous patents. See, for example, U.S. Pat. No. 3,866,568 issued to Minami on Feb. 18, 1975, and U.S. Pat. No. 4,014,287 issued to Green on Mar. 29, 1977 for general information on the book binding process. One of the main steps in bookbinding involves the application of an adhesive to the backbone of the assembled pages of a book or magazine. (As used herein, the term bookbinding applies to the binding of any print publication, including books, magazines and catalogues, and the term book is used to refer to the material being bound, whether a book, a magazine, or a catalogue.) The adhesive is typically glue, and most commonly the glue is made from petroleum based products. In modern bookbinding it is common to use “hot glue” or glue that is heated and that solidifies when it cools. This form of glue solidifies much quicker than other types of glues. The glue is applied to the book back, often called the spine, of the book over a glue wheel or series of glue wheels which are covered with glue that is applied to the backbone.

The application of the glue to the backbone is accomplished by means of glue wheels, which typically obtain the glue from a glue pot. The glue pot is a vessel that holds the liquid glue. Generally a portion of the glue wheel sits in the reservoir of glue and as it rolls the outer surface of the glue wheel picks up glue from the pot and transfers the glue to the top of the wheel. The back of the book, which is often referred to as the spine or backbone, is run over the top of the glue wheel to apply the glue. Typically the spine is pressed against the first glue wheel as it rolls across, which forces the pages apart slightly and allows the glue to spread between the pages. It is important to apply the appropriate amount of glue to the book back. If too little glue is applied the pages may not be properly bonded and the book may fall apart, and if too much glue is applied the pages might stick at an inconvenient distance from the book back and prevent the pages from opening. Glue is often the most expensive component of the book binding process, and the use of excess glue leads to waste, which will increase the cost of the binding process. There is the need, therefore, for a system to precisely control the amount of glue on the glue wheel to ensure sufficient glue to properly bind the book, while minimizing the amount of glue used and minimizing waste.

Another commonly encountered problem is that glue may be applied to too much of the book back. In old systems the glue wheel was entirely covered with glue, and the book back would pick up glue from the leading edge to the trailing edge. In general it is not desirable to get glue on the ends of the book back. There are a couple of reasons for this. One reason is that this glue may seep up between the pages and make the pages stick. One other reason is that it is a waste of glue. This is particularly true in binding magazines, where the ends of the bound book are trimmed off. If there is glue on the ends of the book back and pages it will be trimmed off, and will be totally wasted.

A device, known in the art of bookbinding as the doctor blade, is used to control the amount of glue on the wheel and which thus can be imparted onto the backbone of the book. An example of a prior art doctor blade can be seen in U.S. Pat. No. 6,565,658 issued to Fischer et al., on May 20, 2003. The earliest doctor blades were fixed and therefore only controlled the thickness of the glue on the glue wheel. Modern doctor blades can move, reciprocating into and away from the glue wheel, from an open position where glue is allowed on the glue wheel, to a closed position, which is close enough to the glue wheel to essentially scrape the glue off the glue wheel and prevent glue from contacting the book back. Prior art doctor blades were typically controlled by a cam drive linkage that was attached to the drive mechanism of the machinery that moved the books through the binder. This system is not precise, and can allow too much or too little glue on the wheel, and also cannot be precisely controlled to prevent glue from adhering to the ends of the book back. There is a need, therefore, for a system to precisely control the thickness of the glue on the glue wheel.

### SUMMARY OF THE INVENTION

The invention consists of a doctor blade that is precisely controlled by a direct linkage to limit or control the application of glue to the backbone of the book. The doctor blade is precisely controlled by a linkage attached to a servo motor with a cam, and the servo motor is controlled by a computerized control system to precisely time and position the doctor blade.

The invention is a precisely controlled doctor blade that precisely controls the application of glue on the book back by controlling the glue on the glue wheel by controlled movement of the doctor blade. The doctor blade is moved by a servo motor attached to the doctor blade by a linkage. The servo motor is controlled by a computer operating system that can move the doctor blade based on the length of the book back and the desired placement of glue on the book back. The operating system operates based on information inputted by an operator, and also works with an electric eye that provides information on movement of the books in the binder so that the doctor blade opens and closes as the desired time to place glue in the precise location on the book back. The electric eye also allows the system to deal with a missing book, and prevents the doctor blade from opening, and thus applying glue to the wheel, when a book is missing.

### BRIEF DESCRIPTION OF THE DRAWINGS

FIG. 1 is a perspective view of the invention showing the glue pot and a book on the glue wheels for glue application.

FIG. 2 is a perspective view of the back side of the glue pot with a book on the glue wheel for glue application.

FIG. 3 is a perspective view of the glue pot, the glue wheels, the servo-motors and the doctor blades.

FIG. 4 is a close up perspective detail of the servo motor, the linkage connecting the servo motor to the doctor blade, the doctor blade and the gibs that hold the doctor blade.

FIG. 5 is a close up of the linkage connecting the doctor blade to the servo motor

FIG. 6 is a close up detail of the doctor blade in proximity to the exterior surface of the glue wheel.

FIG. 7 is a schematic of the control components of the invention, showing the relation between the electric eye, the encoder, the computer controller and the servo motors.

FIG. 8 is a flow chart of the steps that controls the servo motor and doctor blade.

### DETAILED DESCRIPTION OF THE INVENTION

Detailed embodiments of the present invention are disclosed herein. It is to be understood that the disclosed embodiments are merely exemplary of the invention, and that there may be a variety of other alternate embodiments. The figures are not necessarily to scale, and some features may be exaggerated or minimized to show details of particular components. Therefore, specified structural and functional details disclosed herein are not to be interpreted as limiting, but merely as a basis for teaching one skilled in the art to employ the varying embodiments of the present invention.

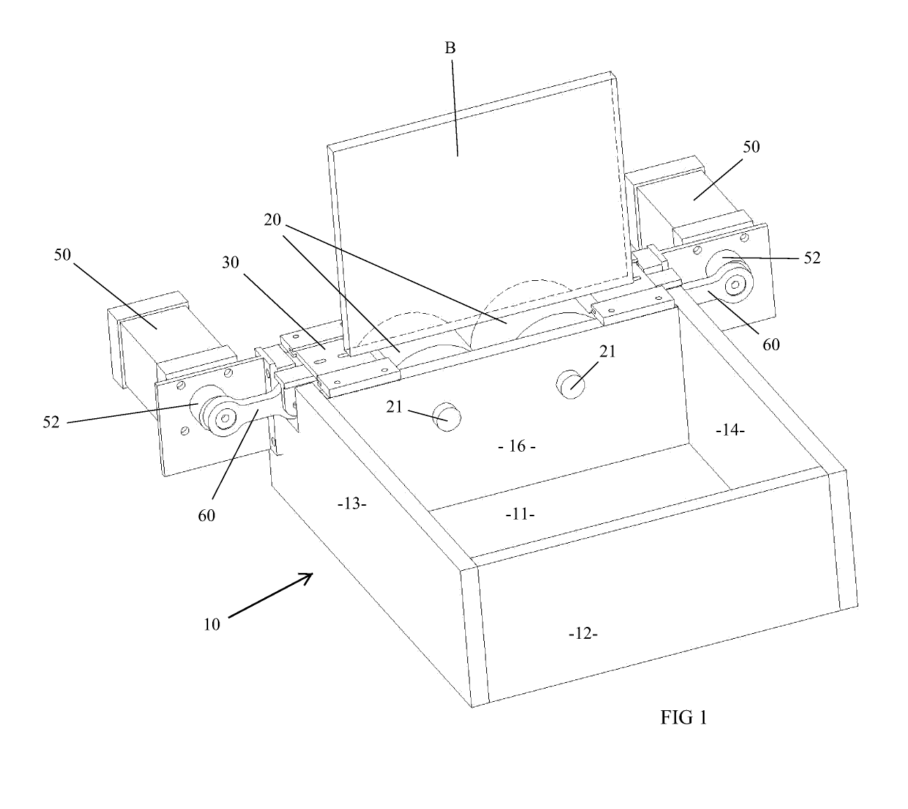

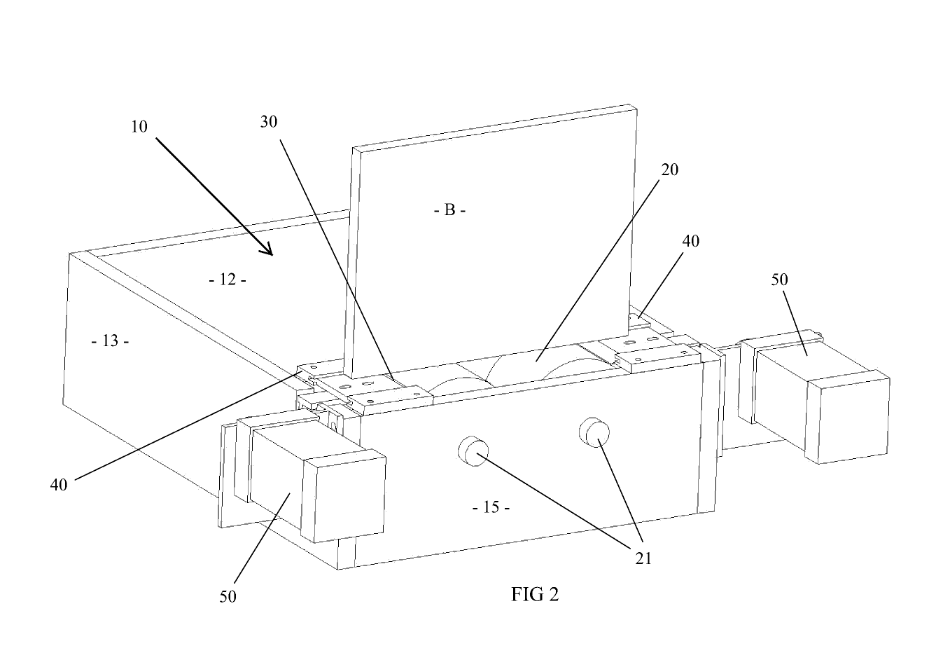

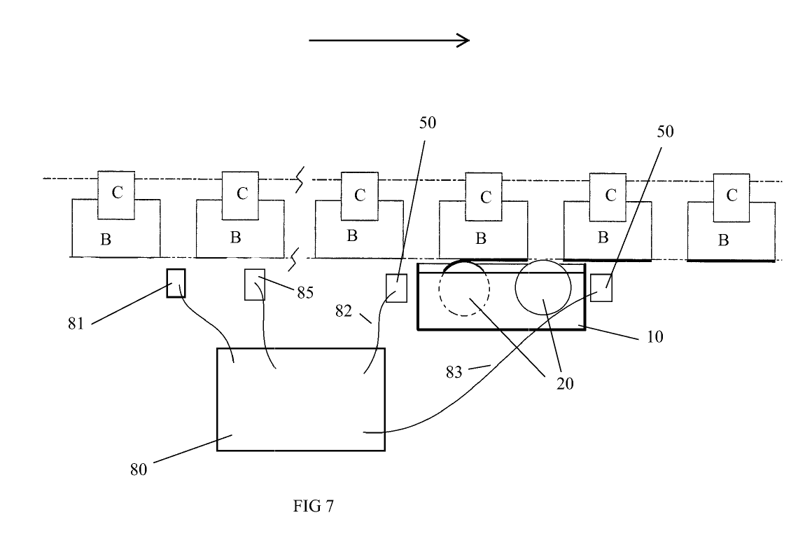

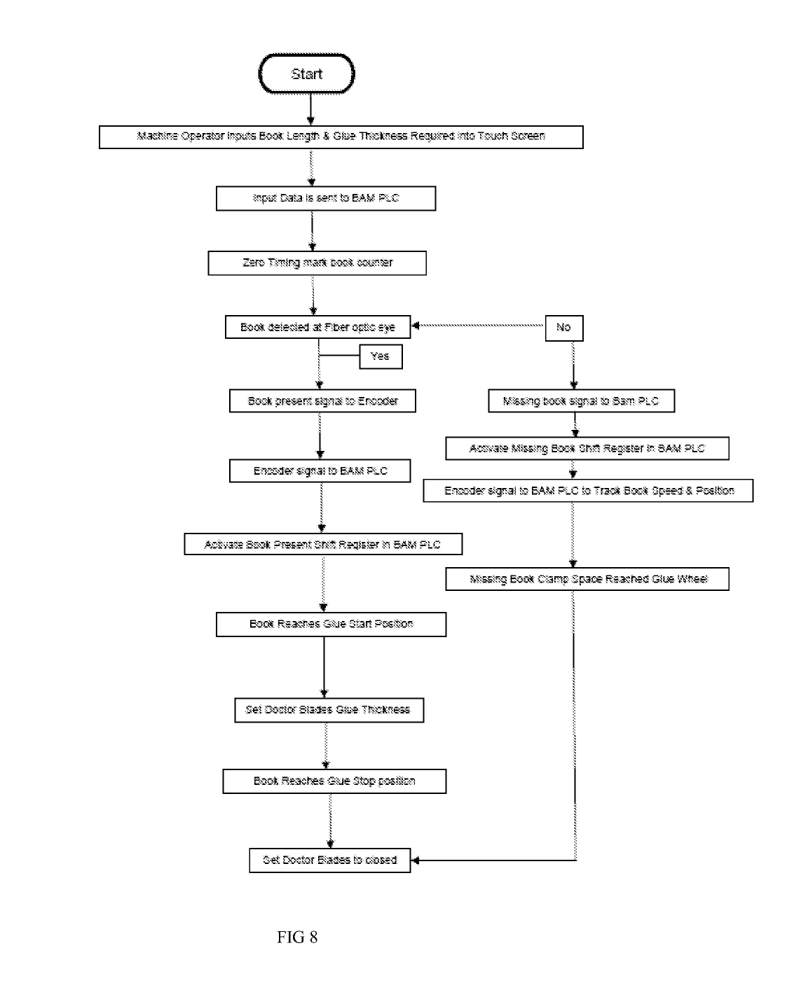

There are two main components of the invention. The first main component is a set of two precisely controlled doctor blades that control the amount of glue on the glue wheels, and hence the amount of glue imparted onto a book back. The doctor blades are controlled by a servo motor. The doctor blades, servo motors and related elements are shown in FIGS. 1-6. The second main component is the controlling apparatus that coordinates between the books moving through the binder and the servo motors to precisely time the opening and closing of the doctor blades to precisely position the glue on the book backs. These elements are shown in FIG. 7, and a flow chart showing the control and operation of the coordinating elements is set forth in FIG. 8.

FIGS. 1 & 2 are overview drawings showing the main components of the glue pot and glue wheels that apply glue G to the book back S of a book B. The components of this portion of the invention are the glue pot 10, the glue wheels 20, the doctor blades 30, the servo motor 50 and the linkage 60 that connects the doctor blade 30 to the servo motor 50. In the embodiment disclosed in the figures there are two glue wheels 20 and two doctor blades 30, servo motors 50 and linkages 60. In the configuration shown the two components are mirror images of each other. For simplicity sake one system will be described, with the understanding that the second system is the mirror image of the first. The glue pot 10 is a container to hold the glue G. The glue pot 10 is made from a pot bottom 11, a front wall 12, a first side wall 13, a second side wall 14 and a back wall 15. The walls 12, 13, 14 & 15 attach to the bottom in the conventional manner to create a container to hold the glue G. There is also an interior wall 16, that runs from the first side wall 13 to the second side wall 14 parallel to the back wall 15. The interior wall 16 does not attach to the pot bottom 11, leaving a small gap which allows the glue G to flow under the interior wall 16. The glue G is hot. It is pre-melted and heated in an external tank and then pumped into the glue pot 10 through a tube. There are a set of heating elements in the bottom of the glue pot 10 to keep the glue G at the proper temperature, which is generally around 350° F. The external heating components, delivery tubing and internal heating elements are known in the prior art and are not show and are not part of the invention.

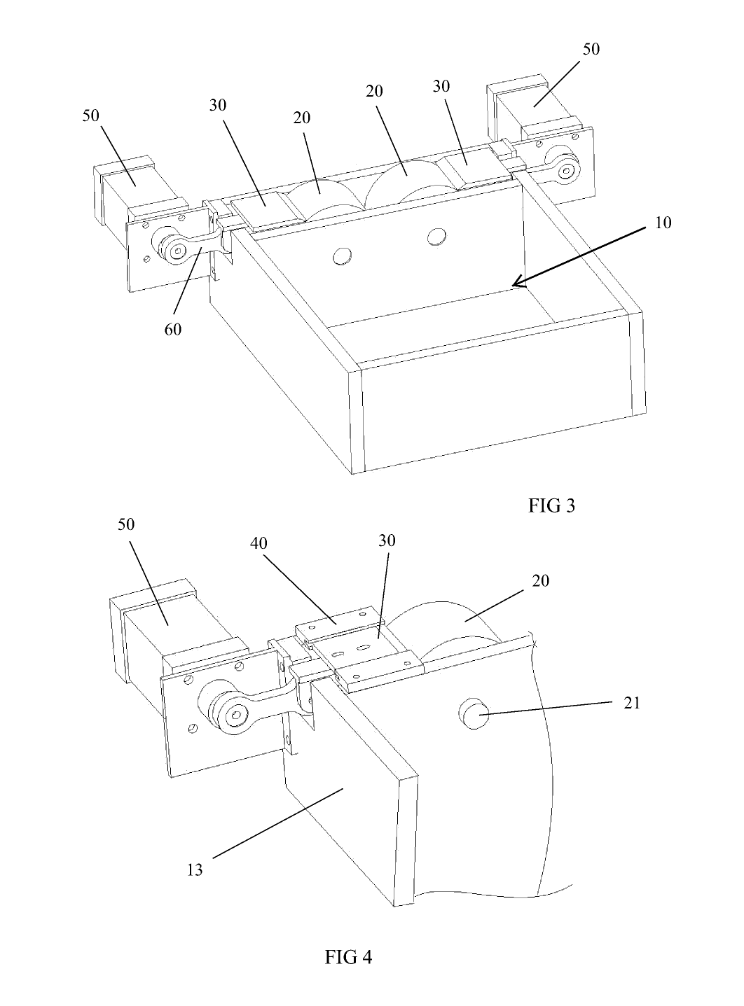

As seen in FIG. 3, there are two glue wheels 20 that are placed between the back wall 15 and the interior wall 16. The wheels run on glue wheel shafts 21 which are attached through shaft holes 25 in the back wall 15 and interior wall 16. The glue wheel 20 turns around the shaft 21. The glue wheels 20 are driven from a separate drive shaft that is attached to the binder so that the glue wheels 20 are running at the same speed as the books B as they move through the binder. This means that the exterior surface 22 of the glue wheel 20 is moving at the same speed as the book back S of the book B. The first wheel 20 rolls in the same direction as the movement of the book B and the second wheel 20 rolls in the opposite direction. The glue wheels have a bottom portion 24 that sits in the glue G, and a top portion 23 which contacts the books B when the books B are run across the glue wheels 20. The glue wheels 20 have an exterior surface 22. When the glue wheel 20 bottom portion 24 is in the glue G, a certain amount of glue G will adhere to the exterior surface 22, and as the glue wheel rolls it picks up the glue G which is present on the top portion 23 for application to the book back S of the books B. The movement of the two glue wheels 20 in opposite direction ensures proper glue G application to the book back S. This is the well known application of binding glue G to the book backs S.

There is a servo motor 50 attached to the side wall near the back wall 15. The servo motors 50 are standard, reciprocating, servo motors, wherein the shaft does not rotate fully but turns a controlled number of degrees. Such servo motors are well known in the art. The servo motor 50 is attached to a mounting plate 55 and the mounting plate 55 is attached to the side wall 13 or 14 near the back wall, as shown in the detail in FIGS. 4 & 5. The servo motor 50 has a shaft 51, and an eccentric cam 52 mounted on the shaft 51. There is a linkage 60 attached to the eccentric cam 52. The linkage 60 has a cam end 61 which is attached to the eccentric cam 52 such that it can roll as the cam moves, and the cam movement forces the linkage 60 to reciprocate back and forth, as described below. The linkage 60 also has a blade end 62 which is mounted to the doctor blade 30 by means of a pin 54.

The doctor blade 30 consists of an attachment arm 35, which is mounted on an attachment plate 34. There is a pin hole 36 in the attachment arm 35, and the pin 54 runs through the attachment hole 36 and attaches the doctor blade 30 to the linkage 60. The doctor blade 30 also has two outwardly extending flanges 33, and a leading edge 32. There are a pair of gibs 40 mounted on the back wall 15 and interior wall 16 near the side wall 13 or 14. The gibs 40 have a recessed channel 43, and the outwardly extending flanges 33 slide in the channels 43. When the doctor blades 30 are slidably mounted in the gibs 40, and with the linkage 60 attaching the doctor blade 30 to the servo motor 50 by means of the eccentric cam 52, the doctor blade 30 will move toward and away from the glue wheel 20.

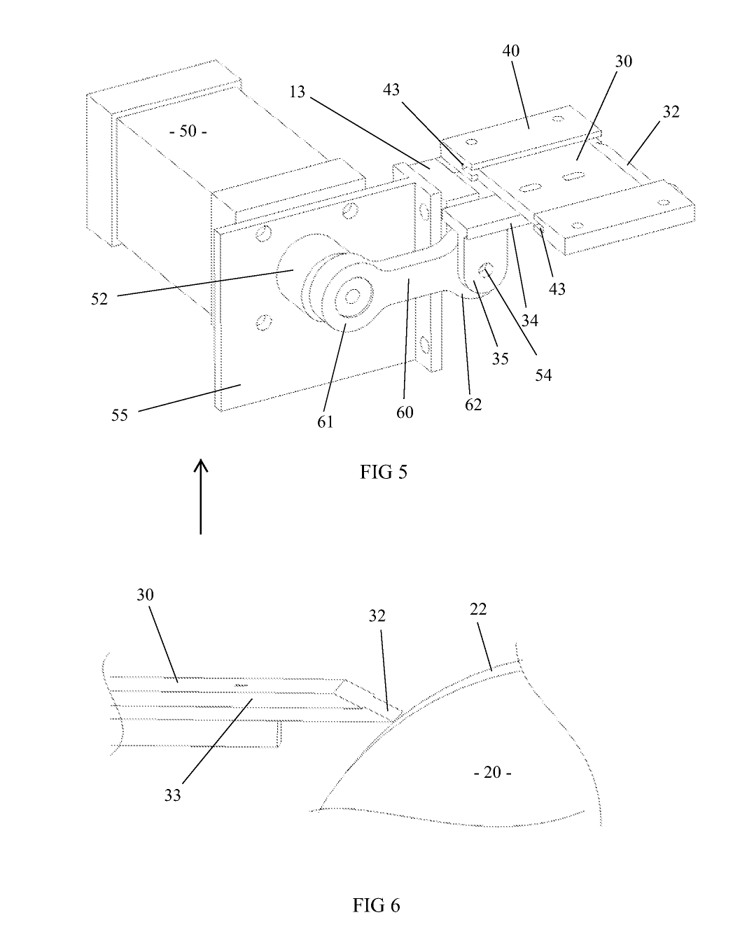

FIG. 6 shows the space between the leading edge 32 of the doctor blade 30 and the exterior surface 22 of the glue wheel 20. Were there no doctor blade 30 present, the glue wheel 20 would pick up glue G and transfers it to the book back S of the book B to glue the pages of the book together. The doctor blade 30 prevents excess glue G from adhering to the book back S. The reciprocating movement of the doctor blade 30 moves the leading edge 32 into and away from the glue wheel 20. When the leading edge 32 is away from the glue wheel 20 it is in the open position, and when the leading edge 32 is moved into and toward the glue wheel 20 it is in the closed position. The doctor blade 30 can also be controlled so that the open position controls the thickness of the glue G on the book back S, and also be precisely controlled to distribute the glue G in the precise location on the book back S, as described below. With the eccentric cam 52 moving the doctor blade 30 the leading edge 32 moves from 0.003 inches from the exterior surface 22 of the glue wheel 20 to 0.035 inches from the exterior surface 22. Therefore, when the doctor blade 30 is in the closed position, the leading edge 32 is 0.003 inches from the exterior surface 22. While the leading edge 32 is not touching the glue wheel 20, this separation is minimal enough so that little or no glue G will remain on the glue wheel. When the doctor blade 30 is in the open position the leading edge 32 can be as far as 0.035 inches from the exterior surface 22. This means that a maximum glue thickness of 0.035 inches is applied to the book back S of the book B. Typical glue thickness ranges from 0.018 inches to 0.035 inches thick, and the servo motor 50 allows precise control of the position of the leading edge 32 of the doctor blade 30 so that the glue thickness on the book back S can be precisely set in any thickness between 0.018 inches to 0.035 inches depending upon the binding requirements of the book B.

The servo motors 50 can precisely control the position of the application of the glue G on the book back S based on the timing and position of the book as it reaches the glue wheel 20.

FIG. 7 is a schematic showing the assembled books B moving in the binder and across the glue wheels 20. Operation of book binding machinery is well known and described herein only to explain the operation of the present invention. A group of pages are collected and held together in a binder clamp C. There is a series of evenly spaced binder clamps C on the binder carriage. The binder carriage is an assembly line of evenly spaced binder clamps C that move around the system in a continuous loop. The binder clamps C are evenly and precisely spaced on the binder carriage to ensure proper operation of the binder machinery, and this spacing is important for the operation of the computerized controlling mechanism that controls the servo motor 50 that controls the doctor blade 30.

In the preferred embodiment there are 27 binder clamps C spaced evenly on 17½″ centers around the binder carriage. Each binder clamp C position is measured from a book register pin that is located in the back of the clamp to the next book clamp register pin. An entire loop of all 27 clamps is referred to as the timing space, which is measured as 360 degrees. Movement of the loop is measured in milliseconds of angular movement, where one full loop is 360 degrees. Depending on the length of the binder loop and the number of binder clamps in the loop, each millisecond correlates to a fraction of an inch. The distance between each register pin, and hence the distance between each clamp, is known as the machine cycle. The machine cycle can be broken down into very small distances.

In the preferred embodiment, the binder carriage is a 360 degree loop. There are 27 binder clamps, each 17½ inches apart. Since the loop is 360 degrees and there are 27 clamps, they are 13.333333 (repeating) degrees apart. That would mean that if the first clamp is at position 0, the second clamp is at 13.333333 (repeating), the third at 26.6666666 (repeating), etc. This means that each machine cycle is 13.33333 degrees. As the system operates, and the binder carriage moves, the encoder 85 sends a pulse signal to the controller. The encoder is operated off the same drive as the carriage and so the pulse signal is generated at the same speed as the movement of the carriage. The encoder signal is sent to the controller and tells the controller how fast the carriage is moving. The software which is internal to the controller is essentially running off information from the 360 degree loop of the carriage. This means that the software knows that a book will arrive at position 0.0, position 13.33 (repeating), position 26.66 (repeating), etc. This will allow the software to activate the servo motors at the appropriate times. The controller can also use the Binder Encoder to divide each Binder machine cycle into small parts. These small parts are then used to determine where book is to within a machine cycle. For example, If the Binder machine cycle is 18 inches and the Binder encoder gives 8000 pulses per machine cycle, the book position is known to 0.00225 inches. Based upon the information provided by the machine operator about the length of the book back, the software knows when the glue should start and stop. For example, if we say that the book is centered at 13.33, the glue will start (for example) at 13.00 and stop at 13.66.

There is a controller 80, which is a computerized control device that controls the operation of the servo motors 50 based on the spacing and movement of the books B and the information about glue application supplied by the system operator. The controller includes an input device that allows the system operator to input information to control the doctor blades 30. In the preferred embodiment the input device is a touch screen monitor, but it could be a standard computer terminal. It is also possible, and within the conception of the invention, to allow the controller to be controlled remotely by a wireless connection to an external computer device such as a tablet computer or laptop. Such computerized control devices are now common and well known in the art. The operator can input the desired glue thickness, which can range from the closed position of 0.003 inches to the maximum open position of 0.035 inches. Typically the applied glue thickness ranges between 0.018 inches and 0.035 inches depending on the type of book being bound. The controller can also input the length of the book back S, as well as the desired distance from the leading edge of the book to begin glue application and desired distance from the trailing edge to end glue application. For most books the distance that glue G begins from the leading edge 51 is 3/32 (0.09375″) of an inch, and application stops at 3/32 (0.09375″) of an inch from the trailing edge S2. The system is designed so that the servo motor 50 will open the doctor blade 30 on the glue wheel 20 at precisely the proper time so that as the glue wheel 20 rolls it will have glue on the wheel for application onto the book back S at the desired point. The doctor blade 30 will then close at the desired time so that the glue will no longer be on the glue wheel 20 at the desired distance from the trailing edge S2 of the book B.

There is an electric eye 81 that is physically attached to the binder and provides an electronic signal to the controller 80 by means of a connecting cable. The electric eye 81 is a standard electric eye and is mounted so that it is triggered by the movement of a book across its field of view. The electric eye 81 records the movement of the books B as they move through the binder system, and also records if there is no book B in a binder clamp C. If there is no book B in the clamp C the controller 80 will not activate the servo motor 50 and the doctor blade 30 will not open. The electric eye 81 that is physically attached to the binder (and precisely located at the “0” degree timing mark inscribed on the binder frame. The binder book clamp is “in time” with the PLC when the binder clamp register pin is lined up precisely with the “0” degree timing mark at “0” degrees in the PLC shift register) and provides an electronic signal to the controller 80 by means of a connecting cable. The electric eye 81 is a standard electric eye and is mounted so that it is triggered by the movement of a book across its field of view. The electric eye 81 (triggers the start of the PLC's shift register countdown) records the movement of the books B as they move through the binder system, and also records if there is no book B in a binder clamp C. If there is no book B in the clamp C the controller 80 will not activate the servo motor 50 and the doctor blade 30 will not open.

There is an encoder 85 that is connected to the binder and in electronic communication with the controller 80 that provides the controller 80 with an encoder signal that has information on the rate of movement of the books B through the binder. In the preferred embodiment the encoder 85 is a simple electromagnetic device that generates a pulse based on the movement of the binder carriage. This pulse is the encoder signal and it is timed to correspond to the movement of the clamps in the binder carriage. The encoder signal allows the controller 80 to know precisely when the leading edge S1 of the book B will come into contract with the glue wheel 20. With the position information provided by the electric eye 81, and the movement information provided by the encoder 85, the computerized controller 80 can be programmed so that the doctor blade 30 will open at the precisely controlled moment so as to begin the placement of glue G at the precisely desired point on the book back S.

The length of the binder carriage loop is precisely known, the distance between the books are known, and the encoder and electric eye communicate the position of the book back S to the controller 80, the controller 80 will know precisely when to activate the servo motor 50 to open the doctor blade 30 to allow the glue G on the glue wheel 20 to reach the book back S and the precise position.

The controller 80 is connected to the first servo motor 50 by means of a first communication cable 82 and connected to the second servo motor 50 by means of the second communication cable 83. Based on the information inputted into the controller 80 by the operator, the controller 80 will take the information from the electric eye 81 and the encoder 85, process it with the control software, and operate the servo motors 50 to precisely open the doctor blade 30 to precisely apply the glue to the book back S.

FIG. 8 is a flow chart showing the operation of the control of the doctor blades 30. The operator inputs the desired glue thickness and book length into the computerized controller 80. The operator can also preset the desired distance that the glue starts and stops on the book back S. This information is provided to the component of the controller that controls the servo motors 50. In the preferred embodiment this component is called the BAM PLC.

The present invention is well adapted to carry out the objectives and attain both the ends and the advantages mentioned, as well as other benefits inherent therein. While the present invention has been depicted, described, and is defined by reference to particular embodiments of the invention, such reference does not imply a limitation to the invention, and no such limitation is to be inferred. The depicted and described embodiments of the invention are exemplary only, and are not exhaustive of the scope of the invention. Consequently, the present invention is intended to be limited only be the spirit and scope of the claims, giving full cognizance to equivalents in all respects.

I CLAIM:

1. A device for controlling the thickness of glue applied to the back of a book during the book binding process, said device comprising:
a glue pot having at least two glue wheels therein;
said glue pot a vessel for holding liquefied glue for application to the back of a book to bind said book;
said glue wheel positioned in glue pot such that a bottom portion is immersed in said liquefied glue and a top portion is positioned such that said book back rolls across said glue wheel for application of said glue;
a doctor blade that is positioned near the glue wheel to control the thickness of the glue on the wheel and hence the glue applied to the book back;
a book binder that collects paper into a book, holds said book in a clamp, and runs said book back of the glue wheel to apply glue to the back of the book;
a means for controlling the position of the doctor blade in relation to the glue to control the thickness of the glue on the wheel.

2. The device for controlling the thickness of glue of claim 1 wherein the means for controlling the position of the doctor blade comprises:
a servo motor having a cam;
a linkage attached between the cam and the doctor blade that allows the servo motor to move the doctor blade to control the position of the doctor blade;
wherein there is a doctor blade closed position with the doctor blade nearly touching the glue wheel to prevent nearly all glue from the wheel, and a doctor blade open position where the doctor blade is away from the glue wheel to allow a desired thickness of glue to adhere to the glue wheel, and
means for coordinating the position of the doctor blade with the position of the book back on the glue wheel.

3. The device for controlling the thickness of glue of claim 2 wherein the means for coordinating the position of the doctor blade comprises:
a computerized control system that controls the movement of the servo motor to control the position of the doctor blade in relation to the glue wheel;
said computerized control system having an input wherein an operator of the book binding system can input the projected speed of the book binder and hence the speed of the book across the glue wheel, the length of the book back, and the desired thickness of the glue on the book back;
wherein said control system activates the servo motor to turn the cam to open the doctor blade and allow glue on the glue wheel as the book back is approaching the glue wheel such that the glue is applied precisely to the book back without excess glue on the glue wheel, and said control system activates the servo motor to turn the cam to close the doctor blade such that there is no glue on the glue wheel when the book back is off the glue wheel,
an electric eye mounted on said book binder to detect the position of the book, said electric eye electronically connected to said control system to impart exact position of the book,
said electric eye can also detect if a book is not present in the system and therefore prevent the doctor blade from opening and allowing glue on the glue wheel.
